(19) United States
(12) Patent Application Publication
(10) Pub. No.: US 2017/0066197 A1
(43) Pub. Date: Mar. 9, 2017

(54) METHOD OF PREPARING THREE-DIMENSIONAL STRUCTURE, AND THREE-DIMENSION FORMING SUPPORT MATERIAL

(71) Applicant: FUJI XEROX CO., LTD., Tokyo (JP)

(72) Inventors: Takashi MORIKAWA, Kanagawa (JP); Takashi OYANAGI, Kanagawa (JP); Toshitake YUI, Kanagawa (JP)

(73) Assignee: FUJI XEROX CO., LTD., Tokyo (JP)

(21) Appl. No.: 14/996,756

(22) Filed: Jan. 15, 2016

(30) Foreign Application Priority Data
Sep. 9, 2015 (JP) 2015-177877

(51) Int. Cl. B29C 67/00; C08L 33/14

(52) U.S. Cl. CPC B29C 67/0092; B29C 67/0059; C08L 33/14; B29K 2105/0002

(57) ABSTRACT

A method of preparing a three-dimensional structure, includes forming a structure made of a cured product of a three-dimension forming material, forming a support portion which supports at least a part of the structure and includes a gas generating component at least at a site which contacts with the structure, generating a gas in the support portion, the gas being derived from the gas generating component, and removing the support portion from the structure.

### CROSS-REFERENCE TO RELATED APPLICATIONS

This application is based on and claims priority under 35 USC 119 from Japanese Patent Application No. 2015-177877, filed Sep. 9, 2015.

### BACKGROUND

1. Technical Field

The present invention relates to a method of preparing a three-dimensional structure, and a three-dimension forming support material.

2. Related Art

A three-dimension forming apparatus, also called a 3D printer, is known as an apparatus for preparing a three-dimensional structure (for example, parts of industrial products, toys such as dolls, and the like), in which the three-dimensional structure is prepared by repeating the following processes of: disposing a forming material (model material) using an ink jet method according to three-dimensional cross-sectional shape data; and curing the forming material with ultraviolet (UV) light or electron beam (EB).

In the three-dimension forming apparatus, in order to form a freely-shaped three-dimensional structure, in the case of forming an overhang or ceiling, a support material for forming a support portion which supports the lower portion of the forming material is required.

When the discharge head of the apparatus has a single nozzle (discharge portion which discharges only one composition), as the support material, the same material as the forming material is used. In this case, unlike the forming material for forming a structure, a method of lowering the density of the forming material to form the support portion and then separating the support portion is used.

As methods of removing these support materials, there are known a breakaway method, a dissolving-removing method, a water jet method, and the like.

### SUMMARY

According to an aspect of the invention, there is provided a method of preparing a three-dimensional structure, including:

forming a structure made of a cured product of a three-dimension forming material;

forming a support portion which supports at least a part of the structure and includes a gas generating component at least at a site which contacts with the structure;

generating a gas in the support portion, the gas being derived from the gas generating component; and

removing the support portion from the structure.

### BRIEF DESCRIPTION OF THE DRAWINGS

Exemplary embodiments of the present invention will be described in detail based on the following figures, wherein:

FIG. 1 is a configuration diagram showing an example of a three-dimension forming apparatus according to the present exemplary embodiment;

FIG. 2A is a process view showing an example of a method of preparing a three-dimensional structure according to the present exemplary embodiment;

FIG. 2B is a process view showing an example of the method of preparing a three-dimensional structure according to the present exemplary embodiment;

FIG. 2C is a process view showing an example of the method of preparing a three-dimensional structure according to the present exemplary embodiment;

FIG. 3 is a process view showing an example of a first modification example of the method of preparing a three-dimensional structure according to the present exemplary embodiment;

FIG. 4 is a process view showing an example of a second modification example of the method of preparing a three-dimensional structure according to the present exemplary embodiment; and

FIG. 5 is a process view showing an example of a third modification example of the method of preparing a three-dimensional structure according to the present exemplary embodiment.

### DETAILED DESCRIPTION

Hereinafter, exemplary embodiments of the present invention will be described in detail.

Method of Preparing a Three-Dimensional Structure

The method of preparing a three-dimensional structure according to the present exemplary embodiment includes: forming a structure made of a cured product of a three-dimension forming material (hereinafter, referred to as “model material”); forming a support portion which supports at least apart of the structure and contains a gas generating component at least at a site which contacts with the structure; generating a gas in the support portion, the gas being derived from the gas generating component; and removing the support portion from the structure.

As methods of removing the support portion well known in the art, for example, a dissolving-removing method, a breakaway method, and a water jet method are known. The dissolving-removing method, for example, is a method of removing the support portion from the structure by dissolving the support portion with a dedicated solution. The breakaway method, for example, is a method of removing the support portion from the structure by stripping the support portion having a low-density made of the model material from the structure by hand or jig. The water jet method, for example, is a method of removing the support portion from the structure by blowing the gel-shaped support portion by water pressure.

However, the dissolving-removing method generally needs 4 hours to 5 hours in order to dissolve the support portion. Although both the breakaway method and the water jet method may realize the removal of the support portion in a shorter amount of time than the dissolving-removing method, when the strippability of the support portion is low, it is necessary to remove the support portion in a careful way such that the structure is not damaged, and thus it takes time to remove the support portion. Particularly, when the shape of the structure is complicated, it takes time to remove the support portion. For this reason, it is currently required to improve the strippability of the support portion.

In contrast, in the method of preparing a three-dimensional structure according to the present exemplary embodiment, a support portion is formed, and then a gas derived from a gas generating component contained in at least a site of the support portion, the site which contacts with the structure, is generated. It is thought that the gas generated in the support portion causes cracks in the support portion, and passes through the interface between the structure and the support portion to be discharged to the outside. For this reason, the adhesiveness at the interface between the structure and the support portion becomes low, and the strippability of the support portion from the structure becomes high. The time to generate the gas is also completed in a short time. Here, the gas derived from the gas generating component refers to a gas generated by the vaporization of the gas generating component or a gas generated by the reaction of the gas generating component.

Thus, in the method of preparing a three-dimensional structure according to the present exemplary embodiment, the strippability of the support portion is improved when a structure made of a cured product of a three-dimension forming material is formed, the support portion which supports at least a part of the structure is formed, and the support portion is removed from the structure. Further, since the strippability of the support portion is improved, it is easy to realize the stripping of the support portion in a short time.

Further, in the method of preparing a three-dimensional structure according to the present exemplary embodiment, since the support portion is easily stripped from the structure, the removal of the support portion from the structure is realized without excessively pulverizing the support portion. For this reason, this support portion is also excellent in disposability after removal. In this regard, in the dissolving-removing method, a waste solution, in which the support portion is dissolved, is discharged in large amounts. In the breakaway method, since a support portion having a low-density is formed using the model material, there is a high tendency of the support portion to be excessively pulverized after removal. In the water jet method, a large amount of a waste solution containing the gel-shaped support portion is discharged.

Hereinafter, the method of preparing a three-dimensional structure according to the present exemplary embodiment will be described in detail.

In the method of preparing a three-dimensional structure according to the present exemplary embodiment, a three-dimensional structure is prepared through the processes of: forming a structure, at least apart thereof being supported by a support portion (structure forming process); generating a gas in the support portion, the gas being derived from a gas generating component (gas generating process); and removing the support portion from the structure (support portion removing process).

Structure Forming Process

In the structure forming process, a structure, at least a part of which is supported by a support portion, is formed. Specifically, a structure, which is supported by a support portion containing a gas generating component at least at a site which contacts with the structure, is formed. In the present exemplary embodiment, an exemplary embodiment in which a gas generating component is contained in the entire support portion will be described. Here, the support portion is formed using a support material containing the gas generating component.

First, a three-dimension forming apparatus (hereinafter, referred to as “three-dimension forming apparatus according to the present exemplary embodiment”) used in the structure forming process will be described.

The three-dimension forming apparatus according to the present exemplary embodiment includes a first discharge unit which accommodates a model material (three-dimension forming material) and discharges the model material, a second discharge unit which accommodates a support material (three-dimension forming support material) and discharges the support material, and a radiation irradiation unit which applies radiation for curing the discharged, model material and support material.

In the three-dimension forming apparatus according to the present exemplary embodiment, a structure is formed by discharging a model material (three-dimension forming material) and curing the model material by irradiation with radiation, and a support supporting at least a part of the structure is formed by discharging a support material (three-dimension forming support material) and curing the support material by irradiation with radiation. Here, the curing of the model material and the support material may be performed together at a time, and may also be performed separately.

The three-dimension forming apparatus according to the present exemplary embodiment may be provided with a model material cartridge (three-dimension forming material cartridge) which accommodates the model material and is detachable from the three-dimension forming apparatus. Similarly, the three-dimension forming apparatus may be provided with a support material cartridge (three-dimension forming support material cartridge) which accommodates the support material and is detachable from the three-dimension forming apparatus.

Next, the three-dimension forming apparatus according to the present exemplary embodiment will be described with reference to the attached drawings.

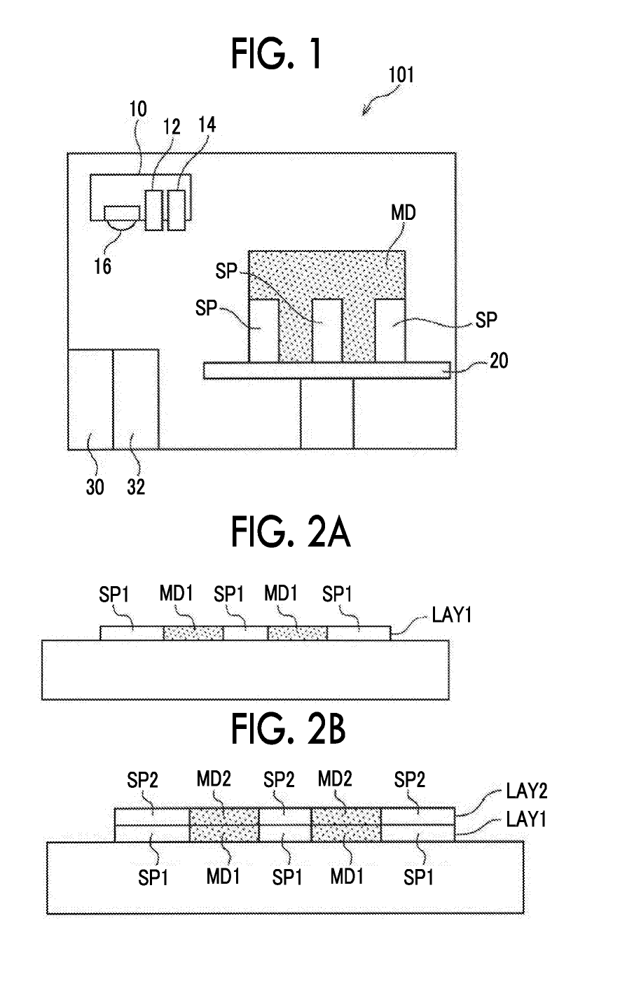

FIG. 1 is a configuration diagram showing an example of the three-dimension forming apparatus according to the present exemplary embodiment.

The three-dimension forming apparatus 101 according to the present exemplary embodiment is an inkjet type three-dimension forming apparatus. As shown in FIG. 1, the three-dimension forming apparatus 101 includes a forming unit 10 and a forming board 20. Further, the three-dimension forming apparatus 101 includes a model material cartridge 30 filled with a model material and detachably mounted in the apparatus and a support material cartridge 32 filled with a support material. In FIG. 1, MD indicates a structure, and SP indicates a support portion.

The forming unit 10 includes a model material discharge head 12 (an example of the first discharge unit) for discharging the droplets of the model material, a support material discharge head 14 (an example of the second discharge unit) for discharging the droplets of the support material, and a radiation irradiation device 16 (radiation irradiation device) for applying a radiation. In addition, the forming unit 10, although not shown, may further include a rotation roller for removing excess model material and support material remaining in the model material and support material discharged on the forming board 20 to flatten the model material and support material.

The forming unit 10 is configured to be moved over the forming region of the forming board 20 by a driving unit (not shown) in a main scanning direction and in a sub-scanning direction intersecting with (for example, perpendicular to) the main scanning direction. That is, the forming unit 10 is configured to be moved by a so-called, carriage method.

Each of the model material discharge head 12 and the support material discharge head 14 discharges the droplets of each of the materials using a piezo method (piezoelectric method) in which the droplets are discharged by pressure. Each of the discharge heads is not limited thereto, and may be a discharge head for discharging each material using pressure from a pump.

The model material discharge head 12 is connected with the model material cartridge 30 through a supply line (not shown). Further, the model material is supplied to the model material discharge head 12 by the model material cartridge 30.

The support material discharge head 14 is connected with the support material cartridge 32 through a supply line (not shown). Further, the support material is supplied to the support material discharge head 14 by the support material cartridge 32.

Each of the model material discharge head 12 and the support material discharge head 14 is a short-length discharge head configured such that its effective discharge region (arrangement region of the nozzles discharging the model material and the support material) is smaller than the forming region of the forming board 20.

Further, each of the model material discharge head 12 and the support material discharge head 14 may be an elongated head which is configured such that its effective discharge region (arrangement region of the nozzles discharging the model material and the support material) is equal to or larger than the forming region width (length in a direction intersecting with (perpendicular to) the moving direction (main scanning direction) of the forming unit 10) of the forming board 20. In this case, the forming unit 10 is configured to move only in the main scanning direction.

The radiation irradiation device 16 is selected depending on the kind of the model material and the support material. As the radiation irradiation device 16, an ultraviolet irradiation device or an electron beam irradiation device is exemplified.

Here, examples of the ultraviolet irradiation device include devices having a light source, such as a metal halide lamp, a high-pressure mercury lamp, super high-pressure mercury lamp, a deep ultraviolet lamp, a lamp to excite the mercury lamp without electrodes from the outside using microwaves, an ultraviolet laser, a xenon lamp, and UV-LED.

Examples of the electron beam irradiation device include a scanning-type electron beam irradiation device, a curtain-type electron beam irradiation device, and a plasma discharge-type electron beam irradiation device.

The forming board 20 has a surface having a forming region in which the model material and the support material are discharged to form a structure. Further, the forming board 20 is configured to be lifted by a driving unit (not shown).

Next, the operation of the three-dimension forming apparatus 101 according to the present exemplary embodiment will be described.

First, through a computer (not shown), two-dimensional shape data (slice data) for forming a structure, as data for three-dimension formation, is created from three-dimensional Computer Aided Design (CAD) data of a three-dimensional structure formed by a model material. In this case, two-dimensional shape data (slice data) for forming a support portion using a support material is also created. The two-dimensional shape data for forming the support portion is configured such that, when the width of an upper structure is larger than the width of a lower structure, in other words, when there is an overhanging portion, a support portion is formed to support portion the overhanging portion from below.

Next, based on the two-dimensional data for forming a structure, the model material is discharged from a model material discharge head 12 while moving the forming unit 10, so as to form a model material layer on the forming board 20. Then, the model material layer is irradiated with a radiation by the radiation irradiation device 16 to cure the model material, thereby forming a layer to be a part of the structure.

If necessary, based on the two-dimensional data for forming a support portion, a support material is discharged from the support material discharge head 14 while moving the forming unit 10, so as to forma support material layer adjacent to the model material layer on the forming board 20. Then, the support material layer is irradiated with a radiation by the radiation irradiation device 16 to cure the support material, thereby forming a layer to be a part of the support portion.

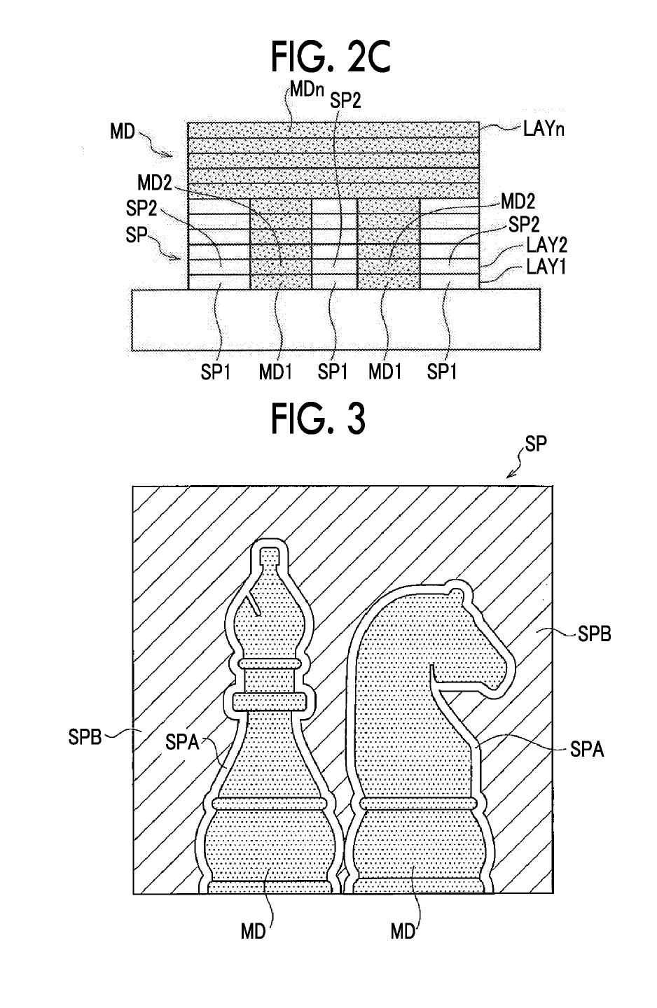

In this way, a first layer LAY1 including the layer to be a part of the structure and, if necessary, the layer to be a part of the support portion is formed (refer to FIG. 2A). Here, in FIG. 2A, MD1 indicates the layer to be a part of the structure in the first layer LAY1, and SP1 indicates the layer to be a part of the support portion in the first layer LAY1.

Next, the forming board 20 descends. Due to the descending of the forming board 20, the thickness of the second layer (second layer including the layer to be a part of the structure and, if necessary, the layer to be a part of the support portion), which will be formed later, is set.

Next, similarly to the first layer LAY1, a second layer LAY2 including the layer to be a part of the structure and, if necessary, the layer to be a part of the support portion is formed (refer to FIG. 2B). Here, in FIG. 2B, MD2 indicates the layer to be a part of the structure in the second layer LAY2, and SP2 indicates the layer to be a part of the support portion in the second layer LAY2.

Further, the operations of forming the first layer LAY1 and the second layer LAY2 are repeatedly conducted to form layers up to the n-th layer LAYn. In this case, a structure having at least a part that is supported with the support portion is formed (refer to FIG. 2C). Here, in FIG. 2C, MDn indicates the layer to be a part of the structure in the n-th layer LAYn. MD indicates the structure. SP indicates the support portion.

Through the above processes, a structure having at least a part that is supported with the support portion is formed.

Gas Generating Process

In the gas generating process, a gas is generated in the support portion supporting the structure. In other words, a gas derived from a gas generating component contained in the support portion is generated. Specifically, for example, a gas derived from a gas generating component is generated in the support portion by heating or irradiation with microwaves.

In the gas generating process, when the structure supported by the support portion is heated, the gas generating component contained in the support portion is vaporized or reacted, so as to generate a gas. Meanwhile, when the structure supported by the support portion is irradiated with microwaves, the gas generating component contained in the support portion generates heat, and is vaporized and reacted, so as to generate a gas. The gas generated in the support portion causes cracks in the support portion, and reduces the adhesiveness at the interface between the structure and the support portion.

Particularly, in the gas generating process, in terms of generating heat from only the gas generating component and reducing the damage of the structure due to the heat, it is preferable to generate a gas by the irradiation with microwaves.

Here, although details will be described later, the gas generating component, for example, is preferably water or water and a blocked isocyanate compound. The gas derived from the gas generating component is preferably at least one of water vapor and carbon dioxide. Water is vaporized into water vapor by heating or irradiation with microwaves. A blocking agent is removed from the blocked isocyanate compound by heating or irradiation with microwaves, and water reacts with an isocyanate group, so as to generate carbon dioxide.

In the gas generating process, the condition for heating the support portion or the condition for irradiating the support portion with microwaves is not particularly limited as long as a gas is generated in the support portion and adhesiveness at the interface between the structure and the support portion is reduced while preventing the damage of the structure.

For example, the condition for heating the support portion may be a heating temperature of 100° C. to 140° C. and a heating time of 1 minute to 10 minutes.

Further, for example, the condition for irradiating the support portion with microwaves may be a frequency of 300 MHz to 3,000 GHz and a wavelength of 0.1 cm to 100 cm (more preferably, S band of 2 MHz to 4 MHz is used). This condition may be a power of 50 W to 1,000 W and an irradiation time of 0.5 minutes to 5 minutes.

Support Portion Removing Process

In the support portion removing process, the support portion is removed from the structure. Specifically, for example, the support portion is removed from the structure such that the support portion is stripped from the structure by a hand or jig. Further, the support portion may be removed from the structure such that the support portion is stripped from the structure by spraying a gas or the like.

Through the above processes, a structure is obtained. Here, the obtained structure may be subjected to post-treatment, such as polishing, painting, or the like.

### MODIFICATION EXAMPLES

The method of preparing a three-dimensional structure according to the present exemplary embodiment is not limited to the above exemplary embodiments, and may be modified or improved. Hereinafter, modification examples of the method of preparing a three-dimensional structure according to the present exemplary embodiment will be described. In the following description, if members are the same as those described in the method of preparing a three-dimensional structure according to the present exemplary embodiment, the same reference numerals are denoted in each drawing, and descriptions thereof will omitted or simplified.

### First Modification Example

The method of preparing a three-dimensional structure according to the present exemplary embodiment, for example, as shown in FIG. 3, may be an exemplary embodiment configured such that a support portion SP, which includes a first support portion SPA which contains a gas generating component and contacts with a structure MD to support the structure MD and a second support portion SPB which supports the structure MD through the first support portion SPA, is formed.

Specifically, for example, the first support portion SPA is formed in a layer so as to contact with the outer periphery of the structure MD, and the second support portion SPB is formed so as to contact with the surface of the first support portion SPA (the surface of a side opposite to the side which contacts with the structure MD). That is, the first support portion SPA which contains a gas generating component is formed so as to be interposed between the outer periphery of the structure MD and the second support portion SPB.

Here, the first support portion SPA is formed of a support material containing a gas generating component. Meanwhile, the second support portion SPB may be formed of a model material, and may also be formed of a model material and a support material containing a gas generating component. That is, the second support portion SPB may be a support portion made of a cured product of a model material, and may also be a support portion made of a cured product of a model material and a support material. Therefore, the second support portion SPB is a support portion having higher strength (hardness) than the first support portion SPA, and is difficult to be excessively pulverized. Further, a dedicated support material may also be used to form the second support portion SPB.

In the first modification example, it is thought that when a gas derived from the gas generating component is generated in the support portion SP (that is, first support portion SPA), the generated gas passes through an interface between the structure MD and the first support portion SPA and an interface between the first support portion SPA and the second support portion SPB, and is discharged. For this reason, adhesiveness at both interfaces is lowered, and, when the support portion SP is removed, the second support portion SPB is easily stripped from the first support portion SPA as a boundary. Thus, the excessive pulverization of the support portion SP (that is, second support portion SPB) is prevented.

### Second Modification Example

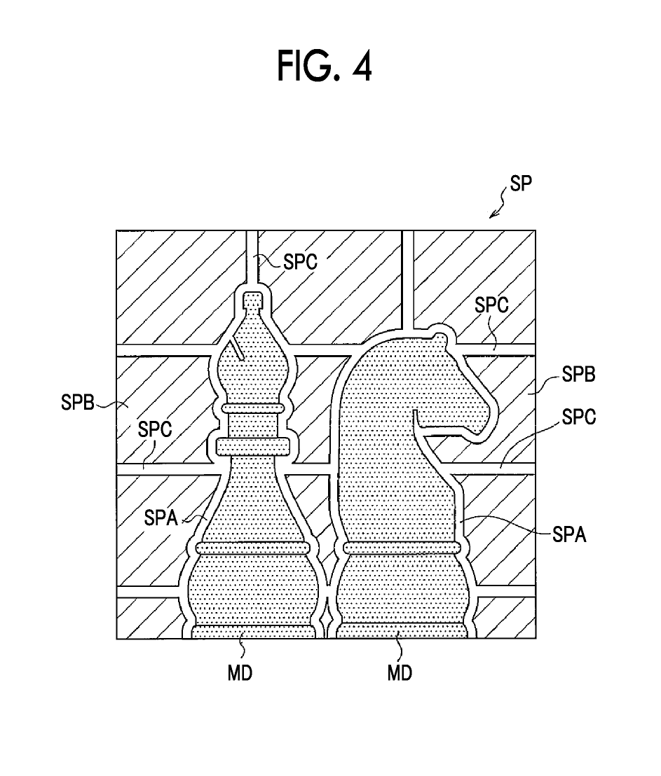

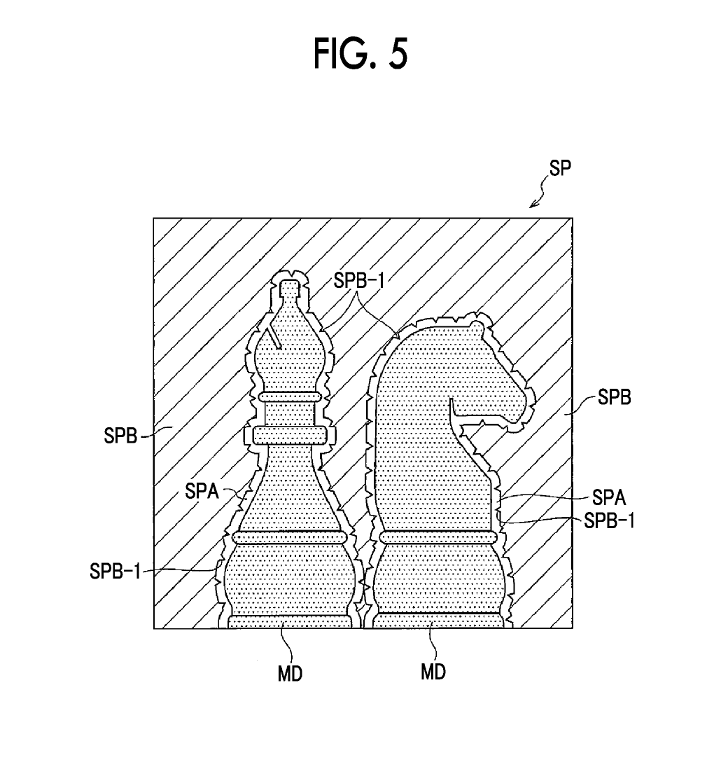

The method of preparing a three-dimensional structure according to the present exemplary embodiment, for example, as shown in FIG. 4, may be an exemplary embodiment configured such that a support portion SP, which includes a first support portion SPA which contains a gas generating component and contacts with a structure MD to support the structure MD, a second support portion SPB which supports the structure MD through the first support portion SPA, and a third support portion SPC which contains a gas generating component and divides the second support portion SPB into plural sections, is formed. That is, the method of preparing a three-dimensional structure according to the present exemplary embodiment, for example, may be an exemplary embodiment configured such that the support portion SP further includes the third support portion SPC which divides the second support portion SPB into plural sections in the first modification example of the method of preparing a three-dimensional structure.

Specifically, for example, the first support portion SPA is formed in a layer so as to contact with the outer periphery of the structure MD, the second support portion SPB is formed so as to contact with the surface of the first support portion SPA (the surface of a side opposite to the side which contacts with the structure MD), and the third support portion SPC is formed in a layer so as to divide the second support portion SPB into plural sections. That is, the first support portion SPA which contains a gas generating component is formed on the outer periphery of the structure MD, and the third support portion SPC which contains a gas generating component is formed so as to be interposed between the plural sections of the second support portion SPB. Further, the first support portion SPA and the third support portion SPC may be formed so as to be connected with each other.

Here, the third support portion SPC is formed of a support material which contains a gas generating component. The first support portion SPA and the second support portion SPB are the same as those in the first modification example.

In the second modification example, when a gas derived from the gas generating component is generated in the support portion SP (that is, first support portion SPA and third support portion SPC), the generated gas passes through an interface between the structure MD and the first support portion SPA, an interface between the first support portion SPA and the second support portion SPB, and an interface between the second support portion SPB and the third support portion SPC, and is discharged. For this reason, adhesiveness at each of the interfaces is lowered, and, when the support portion SP is removed, the second support portion SPB is easily divided and stripped from the first support portion SPA and the third support portion SPC as a boundary. Thus, the excessive pulverization of the support portion SP (that is, second support portion SPB) is prevented.

### Third Modification Example

The method of preparing a three-dimensional structure according to the present exemplary embodiment, for example, as shown in FIG. 4, may be an exemplary embodiment configured such that a support portion SP, which includes a first support portion SPA which contains a gas generating component and contacts with a structure MD to support the structure MD and a second support portion SPB which supports the structure MD through the first support portion SPA and has plural protrusions SPB-1 projecting toward the first support portion SPA, is formed. That is, the method of preparing a three-dimensional structure according to the present exemplary embodiment, for example, may be an exemplary embodiment configured such that the second support portion SPB having the plural protrusions SPB-1 projecting toward the first support portion SPA is formed in the first modification example of the method of preparing a three-dimensional structure.

Specifically, for example, when the first support portion SPA is formed in a layer so as to contact with the outer periphery of the structure MD and the second support portion SPB is formed so as to contact with the surface of the first support portion SPA (the surface of a side opposite to the side which contacts with the structure MD), the first support portion SPA and the second support portion SPB are formed such that a part of the second support portion SPB is embedded in the first support portion SPA in the form of protrusions. That is, when the first support portion SPA containing a gas generating component is formed to be interposed between the outer periphery of the structure MD and the second support portion SPB, the first support portion SPA and the second support portion SPB are formed such that plural protrusions SPB-1 is formed on the surface of the second support portion SPB of a side which contacts with the first support portion SPA and these plural protrusions SPB-1 are embedded on the first support portion SPA. Here, the height of the protrusions SPB-1 may be smaller than the thickness of the first support portion SPA. That is, the protrusions SPB-1 may be embedded in the first support portion SPA without penetrating the first support portion SPA.

Here, the plural protrusions SPB-1 of the second support portion SPB, for example, may be configured such that protrusions SPB-1 having a column shape (column that is not reduced in diameter toward the distal end from the elementary part) or a pyramid shape (pyramid that is reduced in diameter toward the distal end from the elementary part) are irregularly arranged or are regularly arranged (for example, arranged in a lattice shape or the like), and may also be configured such that, in protrusions SPB-1 continuously formed in one direction, protrusions SPB-1 having a polygonal or semicircular section are irregularly arranged or are regularly arranged (for example, arranged in a stripe shape, lattice shape, or the like).

In the third modification example, since the second support portion SPB has the plural protrusions SPB-1, when the removed second support portion SPB contacts with the structure MD, the volume of the first support portion SPA is reduced by the discharge of a gas, and thus surface contact is prevented (that is, point contact becomes easy). Therefore, the re-attachment of the support portion (that is, the second support portion SPB) to the structure MD after removal is prevented.

The third modification example may be applied to the second modification example. That is, in the second modification example, a second support portion SPB having plural protrusions SPB-1 respectively projecting toward the first support portion SPA and the third support portion SPC may be formed.

Model Material (Three-Dimension Forming Material)/Support Material (Three-Dimension Forming Support Material)

Hereinafter, a model material (three-dimension forming material) and a support material (three-dimension forming support material), used in the method of preparing a three-dimensional structure according to the present exemplary embodiment, will be described.

Model Material (Three-Dimension Forming Material)

The model material, for example, contains a radiation-curable compound. The model material may contain other additives, such as a radiation polymerization initiator, a polymerization inhibitor, a surfactant, and a color material, in addition to the above components.

Radiation-Curable Compound

The radiation-curable compound is a compound cured (polymerized) by radiation (ultraviolet light or electron beam). The radiation-curable compound may be a monomer, and may also be an oligomer.

As the radiation-curable compound, a compound having a radiation-curable functional group (radiation-polymerizable functional group) is exemplified. As the radiation-curable functional group, an ethylenically unsaturated double bond (for example, a N-vinyl group, a vinyl ether group, a (meth)acryloyl or group), an epoxy group, or an oxetanyl group is exemplified. The radiation-curable compound may be a compound having an ethylenically unsaturated bond group (preferably a (meth)acryloyl group).

Specifically, preferable examples of the radiation-curable compound include urethane (meth)acrylate, epoxy (meth)acrylate, and polyester (meth)acrylate. Among these, the radiation-curable compound may be urethane (meth)acrylate.

In the present specification, (meth)acrylate refers to both of acrylate and methacrylate. Further, (meth)acryloyl refers to both of acryloyl and methacryloyl.

Urethane (Meth)Acrylate

Urethane (meth)acrylate (hereinafter, simply “urethane (meth)acrylate”) is a compound having a urethane structure and two or more (meth)acryloyl groups in one molecule. Urethane (meth)acrylate may be a monomer, and may also be an oligomer, but, preferably is an oligomer.

The number of functional groups ((meth)acryloyl group) of urethane (meth)acrylate may be 2 to 20 (preferably 2 to 15).

Examples of urethane (meth)acrylate include reaction products of a polyisocyanate compound, a polyol compound, and hydroxyl group-containing (meth)acrylate. Specifically, as urethane (meth)acrylate, which is a prepolymer obtained by the reaction of a polyisocyanate compound and a polyol compound, there is exemplified a reaction product of a prepolymer having an isocyanate group at the terminal thereof with hydroxyl group-containing (meth)acrylate. In addition, as urethane (meth)acrylate, there is exemplified a reaction product of a polyisocyanate compound with hydroxyl group-containing (meth) acrylate.

Polyisocyanate Compound

Examples of the polyisocyanate compound include chain saturated hydrocarbon isocyanate, cyclic saturated hydrocarbon isocyanate, and aromatic polyisocyanate. Among these, as the polyisocyanate compound, chain saturated hydrocarbon isocyanate having no light absorption band in a near-ultraviolet region, or cyclic saturated hydrocarbon isocyanate having no light absorption band in a near-ultraviolet region is preferable.

Examples of the chain saturated hydrocarbon isocyanate include tetramethylene diisocyanate, hexamethylene diisocyanate, 2,2,4-trimethylhexamethylene diisocyanate, and 2,4,4-trimethylhexamethylene diisocyanate.

Examples of the cyclic saturated hydrocarbon isocyanate include isophorone diisocyanate, norbornane diisocyanate, dicyclohexylmethane diisocyanate, methylene bis (4-cyclohexyl isocyanate), hydrogenated diphenylmethane diisocyanate, hydrogenated xylene diisocyanate, and hydrogenated toluene diisocyanate.

Example of the aromatic polyisocyanate include 2,4-tolylene diisocyanate, 1,3-xylylene diisocyanate, p-phenylene diisocyanate, 3,3′-dimethyl-4,4′-diisocyanate, 6-isopropyl-1,3-phenyl-diisocyanate, and 1,5-naphthalene diisocyanate.

Polyol Compound

Examples of the polyol compound include diols and polyols.

Examples of diols include alkylene glycols (for example, ethylene glycol, 1,2-propanediol, 1,3-propanediol, 2-methyl-1,3-propanediol, 1,3-butanediol, 1,4-butanediol, 1,5-pentanediol, 2-methyl-1,5-pentanediol, neopentyl glycol, 3-methyl-1,5-pentanediol, 2,3,5-trimethyl-1,5-pentanediol, 1,6-hexanediol, 2-ethyl-1,6-hexanediol, 2,2,4-trimethyl-1,6-hexanediol, 1,8-octanediol, 1,9-nonanediol, 1,10-decanediol, 1,12-dodecanediol, 1,14-tetradecanediol, 1,16-hexadecanediol, 1,2-dimethylol cyclohexane, 1,3-dimethylol cyclohexane, and 1,4-dimethylol cyclohexane).

Examples of polyols include alkylene polyols having three or more hydroxyl groups (for example, glycerin, trimethylolethane, trimethylolpropane, 1,2,6-hexanetriol, 1,2,4-butanetriol, erythritol, sorbitol, pentaerythritol, dipentaerythritol, and mannitol).

Examples of the polyol compound include polyether polyols, polyester polyols, and polycarbonate polyols.

Examples of polyether polyols include multimers of polyols, adducts of polyols and alkylene oxide, and ring-opened polymers of alkylene oxide.

Here, examples of polyols include ethylene glycol, diethylene glycol, propylene glycol, dipropylene glycol, 1,4-butanediol, 1,3-butanediol, neopentyl glycol, 1,6-hexanediol, 1,2-hexanediol, 3-methyl-1,5-pentanediol, 2-butyl-2-ethyl-1,3-propanediol, 2,4-diethyl-1,5-pentanediol, 1,8-octanediol, 1, 9-nonane diol, 2-methyl-1,8-octanediol, 1,8-decanediol, octadecane diols, glycerol, trimethylolpropane, pentaerythritol, and hexane triol.

Examples of alkylene oxide include ethylene oxide, propylene oxide, butylene oxide, styrene oxide, epichlorohydrin, and tetrahydrofuran.

Examples of polyester polyols include reaction products of polyols and dibasic acids, and ring-opened polymers of cyclic ester compounds.

Here, examples of polyols are the same as those of polyols exemplified in the description of polyether polyols.

Examples of dibasic acids include carboxylic acids (for example, succinic acid, adipic acid, sebacic acid, dimer acid, maleic acid, phthalic acid, isophthalic acid, and terephthalic acid), and anhydrides of carboxylic acids.

Examples of cyclic ester compounds include ε-caprolactone, and β-methyl-δ-valerolactone.

Examples of polycarbonate polyols include reaction products of glycols and alkylene carbonates, reaction products of glycols and diaryl carbonates, and reaction products of glycols and dialkyl carbonates.

Here, examples of alkylene carbonates include ethylene carbonate, 1,2-propylene carbonate, and 1,2-butylene carbonate. Examples of diaryl carbonates include diphenyl carbonate, 4-methyl diphenyl carbonate, 4-ethyl diphenyl carbonate, 4-propyl diphenyl carbonate, 4,4′-dimethyl diphenyl carbonate, 2-tolyl-4-tolyl carbonate, 4,4′-diethyl diphenyl carbonate, 4,4′-dipropyl diphenyl carbonate, phenyl toluyl carbonate, bischlorophenyl carbonate, phenyl chlorophenyl carbonate, phenyl naphthyl carbonate, and dinaphthyl carbonate.

Examples of dialkyl carbonates include dimethyl carbonate, diethyl carbonate, di-n-propyl carbonate, diisopropyl carbonate, di-n-butyl carbonate, diisobutyl carbonate, di-t-butyl carbonate, di-n-amyl carbonate, and diisoamyl carbonate.

Hydrogen Group-Containing (Meth)Acrylate

Examples of hydrogen group-containing (meth)acrylate include 2-hydroxyethyl (meth) acrylate, 2-hydroxypropyl (meth) acrylate, 2-hydroxybutyl (meth)acrylate, 2-hydroxy-3-phenoxypropyl (meth)acrylate, glycerin di(meth)acrylate, trimethylolpropane di(meth)acrylate, pentaerythritol tri(meth)acrylate, and dipentaerythritol penta(meth)acrylate. Examples of hydrogen group-containing (meth)acrylate include adducts of glycidyl group-containing compounds (for example, alkyl glycidyl ether, allyl glycidyl ether, and glycidyl (meth)acrylate) and (meth)acrylic acids.

Weight Average Molecular Weight of Urethane (Meth)Acrylate

The weight average molecular weight of urethane (meth)acrylate is preferably 500 to 5,000, and more preferably 1,000 to 3,000.

The weight average molecular weight of urethane (meth)acrylate is a value measured by gel permeation chromatography (GPC) using polystyrene as a standard substance.

Other Radiation-Curable Compounds

As the radiation-curable compound, other radiation-curable compounds are also exemplified in addition to the above radiation-curable compound.

Examples of other radiation-curable compounds are exemplified as follows. Examples of other photocurable compounds include (meth)acrylates (monofunctional (meth)acrylates, polyfunctional (meth)acrylates).

Examples of monofunctional (meth)acrylates include linear, branched, or cyclic alkyl (meth)acrylates, (meth)acrylates having a hydroxyl group, (meth)acrylates having a heterocyclic ring, and (meth)acrylamide compounds.

Examples of alkyl (meth)acrylates include methyl (meth)acrylate, ethyl (meth)acrylate, isobutyl (meth)acrylate, t-butyl (meth)acrylate, lauryl (meth)acrylate, stearyl (meth)acrylate, isostearyl (meth)acrylate, cyclohexyl (meth)acrylate, 4-t-cyclohexyl (meth)acrylate, isobornyl (meth)acrylate, and dicyclopentanyl (meth)acrylate.

Examples of (meth)acrylates having a hydroxyl group include hydroxyethyl (meth)acrylate, hydroxypropyl (meth)acrylate, 4-hydroxybutyl (meth)acrylate, polyethylene glycol mono(meth)acrylate, methoxypolyethylene glycol mono (meth)acrylate, polypropylene glycol mono (meth)acrylate, methoxy polypropylene glycol mono(meth)acrylate, and mono(meth)acrylate of block polymer of polyethylene glycol-polypropylene glycol.

Examples of (meth)acrylates having a heterocyclic ring include tetrahydrofurfuryl (meth)acrylate, 4-(meth)acryloyloxymethyl-2-methyl-2-ethyl-1,3-dioxolane, 4-(meth)acryloyloxymethyl-2-cyclohexyl-1,3-dioxolane, and adamantyl (meth)acrylate.

Examples of (meth)acrylamide compounds include (meth)acrylamide, N-methyl (meth)acrylamide, N-ethyl (meth)acrylamide, N-propyl (meth)acrylamide, N-butyl (meth)acrylamide, N, N′-dimethyl (meth)acrylamide, N, N′-diethyl (meth)acrylamide, N-hydroxyethyl (meth)acrylamide, N-hydroxypropyl (meth)acrylamide, and N-hydroxybutyl (meth)acrylamide.

Among polyfuctional (meth)acrylates, examples of difunctional (meth)acrylates include 1,10-decanediol diacrylate, 2-methyl-1,8-octanediol diacrylate, 2-butyl-2-ethyl-1,3-propanediol diacrylate, 1,9-nonane diol diacrylate, 1,8-octanediol diacrylate, 1,7-heptanediol diacrylate, polytetramethylene glycol diacrylate, 3-methyl-1,5-pentanediol diacrylate, 1,6-hexanediol diacrylate, neopentyl glycol diacrylate, hydroxypivalic neopentyl glycol diacrylate, tripropylene glycol diacrylate, 1,4-butanediol diacrylate, dipropylene glycol diacrylate, 2-(2-vinyloxyethoxy) ethyl acrylate, ethylene oxide (EO)-modified bisphenol A diacrylate, propylene oxide (PO)-modified bisphenol A diacrylate, ethylene oxide (EO)-modified hydrogenated bisphenol A diacrylate, and ethylene oxide (EO)-modified bisphenol F diacrylate.

Among polyfuctional (meth)acrylates, examples of tri- or higher functional (meth)acrylates include trimethylolpropane triacrylate, ethoxylated trimethylolpropane triacrylate, propoxylated trimethylolpropane triacrylate, pentaerythritol triacrylate, ethoxylated glycerol triacrylate, tetramethylolmethane triacrylate, pentaerythritol tetraacrylate, ethoxylated pentaerythritol tetraacrylate, ethylene oxide (EO)-modified diglycerol tetraacrylate, ditrimethylolpropane tetraacrylate-modified acrylate, dipentaerythritol pentaacrylate, and dipentaerythritol hexaacrylate.

Content of Radiation-Curable Compound

The content of the radiation-curable compound is preferably 90% by weight to 99% by weight, and more preferably 93% by weight to 97% by weight, based on the total amount of the model material.

In particular, the radiation-curable compound is preferably used in combination with urethane (meth)acrylate and the above other radiation-curable compounds. In this case, the content of urethane (meth)acrylate is preferably 10% by weight to 60% by weight, and more preferably 20% by weight to 50% by weight, based on the total amount of the model material. Meanwhile, the content of the above other radiation-curable compounds is preferably 40% by weight to 75% by weight, and more preferably 50% by weight to 65% by weight, based on the total amount of the support material.

Here, the radiation-curable compounds may be used alone or in a combination of two or more.

Radiation Polymerization Initiator

As the radiation polymerization initiator, well-known polymerization initiators, such as radiation radical polymerization initiators and radiation cationic polymerization initiators, are exemplified.

Examples of the radiation radical polymerization initiator include aromatic ketones, acylphosphine oxide compounds, aromatic onium salt compounds, organic peroxides, thio compounds (thioxanthone compounds, thiophenyl group-containing compounds, and the like), hexaarylbiimidazole compounds, ketoxime ester compounds, borate compounds, azinium compounds, metallocene compounds, active ester compounds, compounds having a carbon-halogen bond, and alkyl amine compounds.

Specific examples of the radiation radical polymerization initiator include well-known radiation polymerization initiators, such as acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophenone, 4-chlorobenzophenone, 4,4′-dimethoxy benzophenone, 4,4′-diamino benzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenyl-propan-1-one, thioxanthone, diethyl thioxanthone, 2-isopropyl thioxanthone, 2-chloro thioxanthone, 2-methyl-1-[4-(methylthio)phenyl]-2-morpholino-propan-1-one, bis(2,4,6-trimethylbenzoyl)-phenyl phosphine oxide, 2,4,6-trimethylbenzoyl-diphenyl-phosphine oxide, 2,4-diethyl thioxanthone, and bis-(2,6-dimethoxybenzoyl) 2,4,4-trimethylpentyl phosphine oxide.

Content of Radiation Polymerization Initiator

The content of the radiation polymerization initiator, for example, is preferably 1% by weight to 10% by weight, and more preferably 3% by weight to 5% by weight, based on the total amount of the radiation curable compound.

Here, the radiation polymerization initiator may be used alone or in a combination of two or more.

Polymerization Inhibitor

Examples of the polymerization inhibitor include well-known polymerization inhibitors, such as phenolic polymerization inhibitors (for example, p-methoxy phenol, cresol, t-butyl catechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), and the like), hindered amine, hydroquinone monomethyl ether (MEHQ), and hydroquinone.

Content of Polymerization Inhibitor

The content of the polymerization inhibitor, for example, is preferably 0.1% by weight to 1% by weight, and more preferably 0.3% by weight to 0.5% by weight, based on the total amount of the radiation-curable compound.

Here, the polymerization inhibitor may be used alone or in a combination of two or more.

Surfactant

Examples of the surfactant include well-known surfactants, such as silicone surfactants, acrylic surfactants, cationic surfactants, anionic surfactants, nonionic surfactants, amphoteric surfactants, and fluorine surfactants.

Content of Surfactant

The content of the surfactant, for example, is preferably 0.05% by weight to 0.5% by weight, and more preferably 0.1% by weight to 0.3% by weight, based on the total amount of the radiation-curable compound.

Here, the surfactant may be used alone or in a combination of two or more.

Other Additives

In addition to the above additives, examples of other additives include well-known additives, such as a colorant, a solvent, a sensitizer, a fixing agent, a fungicide, a preservative, an antioxidant, an ultraviolet absorber, a chelating agent, a thickener, a dispersing agent, a polymerization accelerator, a penetration enhancer, and a wetting agent (moisturizer).

Characteristics of Model Material

The surface tension of the model material is present in a range of 20 mN/m to 40 mN/m.

Here, the surface tension thereof is a value measured using a Wilhelmy type surface tension meter (manufactured by Kyowa Interface Science Co., Ltd.) under an environment of a temperature of 23° C. and a relative humidity (RH) of 55%.

The viscosity of the model material is present in a range of 30 mPa·s to 50 mPa·s.

Here, the viscosity thereof is a value measured using the Rheomat 115 (manufactured by Contraves) as a measurement device under a condition of a temperature of 23° C. and a shear rate of 1400 s⁻¹.

Support Material

The support material according to the present exemplary embodiment contains a radiation-curable compound, a gas generating component, and a plasticizer. The support material may contain other additives, such as a radiation polymerization initiator, a polymerization inhibitor, a surfactant, and a color material, in addition to the above components.

Specifically, the support material, for example, may be a support material including a radiation-curable compound, a gas generating component containing water or containing water and a blocked isocyanate, and a plasticizer. Specific examples of the support material include: 1) a support material including a radiation-curable compound, a gas generating component containing water and a blocked isocyanate, and a plasticizer; and 2) a support material including a radiation-curable compound, a gas generating component containing water, a hydrophilic compound different from the radiation-curable compound, and a plasticizer. However, preferably, the support material 1) also include a hydrophilic compound, from the viewpoint of stably retaining water in the support material.

Meanwhile, the support material may use the components exemplified in the model material in addition to a gas generating component, a hydrophilic compound, and a plasticizer. The characteristics of the support material are also exemplified in the same range as the characteristics of the model material. Therefore, descriptions of components other than a gas generating component and a plasticizer will be omitted. However, as the radiation-curable compound (radiation-curable compound having the highest content among the radiation-curable compounds), which is a main component, a hydrophilic radiation-curable compound may be applied, from the viewpoint of stably retaining water (dissolved in water) in the support material.

Gas Generating Component

As the gas generating component, water, or water and blocked isocyanate is exemplified. The gas generating component is preferably water, from the viewpoint of the volume of the generated gas by wt being large. That is, the generated gas is preferably water vapor.

Examples of other gas generating components include azo polymerization initiators, such as sodium hydrogen carbonate, ammonium carbonate, and diazoaminobenzene; and nitrosoamine compounds, such as N,N′-dinitrosopentamethylenetetramine

Examples of water include distilled water, ion-exchange water, ultrafiltration water, and pure water.

Meanwhile, a blocked isocyanate compound is a compound having one or more isocyanate groups protected with a blocking agent (isocyanate groups obtained by reacting a compound having active hydrogen which is a blocking agent). When the blocking agent is heated to predetermined temperature or higher, the blocking agent is desorbed from the isocyanate group, and reacts with adjacent water to generate carbon dioxide.

Examples of isocyanate compounds include tolylene diisocyanate, diphenylmethane-4,4′-diisocyanate, hexamethylene diisocyanate, isophorone diisocyanate, dicyclohexylmethane diisocyanate, and polymethylene polyphenyl polyisocyanate. Further, examples of isocyanate compounds include dimers and trimers thereof.

Meanwhile, examples of the blocking agent include lactams, such as caprolactam; oximes, such as methyl ethyl ketoxime and acetone oxime; and β-diketones, such as diethyl malonate and diethyl acetoacetate. In addition, examples of the blocking agent include well known blocking agents, such as phenols, alcohols, dimethyl malonate, ethyl acetoacetate, and dimethylpyrazole.

The content of the gas generating component is preferably 5% by weight to 30% by weight, more preferably 8% by weight to 25% by weight, and still more preferably 10% by weight to 20% by weight, based on the total amount of the support material.

Specifically, when the gas generating component is water, the content of water as the gas generating component is preferably 5% by weight to 20% by weight, and more preferably 8% by weight to 15% by weight, based on the total amount of the support material.

Further, when the gas generating component is water and the blocked isocyanate compound, the content of water and the blocked isocyanate compound as the gas generating component is preferably 5% by weight to 20% by weight, and more preferably 8% by weight to 15% by weight, based on the total amount of the support material.

Hydrophilic Compound

The hydrophilic compound refers to a compound in which 0.1 g or more of water is dissolved with respect to 100 g of the hydrophilic compound at a temperature of 25° C. The hydrophilic compound is a compound which functions to stably retain (dissolve) water in the support material. However, the hydrophilic compound, if necessary, is a compound contained in the support material.

Here, the hydrophilic compound different from a radiation-curable compound does not mean that this hydrophilic compound is a non-radiation-curable compound, and means that this hydrophilic compound is a hydrophilic radiation-curable compound or a hydrophilic non-radiation-curable compound, which is different from the radiation-curable compound (radiation-curable compound having the highest content among the radiation-curable compounds), which is a main component contained in the support material. Specifically, for example, when a urethane (meth)acrylate oligomer is contained in the support material as the radiation-curable compound which is a main component, a hydrophilic radiation-curable compound or a hydrophilic non-radiation-curable compound, which is different from the urethane (meth)acrylate oligomer, is used as the hydrophilic compound.

Examples of the radiation-curable compound as the hydrophilic compound include (meth)acrylate having a hydroxyl group, a (meth)acrylamide compound, (meth)acryloyl morpholine, methoxy polyethylene glycol (meth)acrylate, methoxy polyoxyethylene glycol (meth)acrylate, polyethylene glycol di(meth)acrylate, and ethoxylated trimethylolpropane tri(meth)acrylate.

Examples of the non-radiation-curable compound as the hydrophilic compound include glycerin, polyethylene glycol, polypropylene glycol, polyvinyl alcohol, polypyrrole, polyacrylamide, poly-N-vinylacetamide, polyether polyols, castor oil polyols, and polyester polyols.

Among these, from the viewpoint of stably retaining water (dissolved in water) in the support material, particularly, the hydrophilic compound is preferably selected from (meth)acrylate having a hydroxyl group, a (meth)acrylamide compound, methoxy polyethylene glycol (meth)acrylate, methoxy polyoxyethylene glycol (meth)acrylate, polyethylene glycol di(meth)acrylate, glycerin, polyethylene glycol, polypropylene glycol, polyether polyols, castor oil polyols, and polyester polyols.

These hydrophilic compounds may be used alone or in a combination of two or more.

Here, the combination of a radiation-curable compound and a hydrophilic compound is preferably a combination of one radiation-curable compound selected from mono-functional acrylates and difunctional acrylates and one hydrophilic compound selected from polyethylene glycol, polypropylene glycol, polyether polyols, castor oil polyols, and polyester polyols.

The content of the hydrophilic compound is preferably 30% by weight to 90% by weight, more preferably 40% by weight to 85% by weight, and still more preferably 50% by weight to 80% by weight, based on the total amount of the support material.

Plasticizer

As the plasticizer (however, plasticizer excluding water), a non-radiation-curable polymer is exemplified. The non-radiation-curable polymer is a polymer which does not cause a curing (polymerization) reaction by radiation (for example, ultraviolet light or electron beam).

The non-radiation-curable polymer is preferably at least one selected from polyether polyols, castor oil polyols, and polyester polyols.

Polyether Polyol

Examples of polyether polyols include multimers of polyols, adducts of polyols and alkylene oxides, and ring-opened polymers of alkylene oxides.

Examples of polyols include ethylene glycol, diethylene glycol, propylene glycol, dipropylene glycol, 1,4-butanediol, 1,3-butanediol, neopentyl glycol, 1,6-hexanediol, 1,2-hexanediol, 3-methyl-1,5-pentanediol, 2-butyl-2-ethyl-1,3-propanediol, 2,4-diethyl-1,5-pentanediol, 1,8-octanediol, 1, 9-nonane diol, 2-methyl-1,8-octanediol, 1,8-decanediol, octadecane diol, glycerin, trimethylolpropane, pentaerythritol, and hexane triol.

Examples of alkylene oxides include ethylene oxide, propylene oxide, butylene oxide, styrene oxide, epichlorohydrin, and tetrahydrofuran.

Castor Oil Polyol

As the castor oil polyol, denatured castor oil obtained by modifying castor oil with polyol, or denatured castor fatty acid obtained by modifying castor fatty acid (fatty acid obtained from castor oil) with polyol is exemplified.

Here, examples of polyols are the same as those of polyols exemplified in the description of polyether polyols.

Polyester Polyol

Examples of polyester polyols include reaction products of polyols and dibasic acids, and ring-opened polymers of cyclic ester compounds.

Examples of polyols are the same as those of polyols exemplified in the description of polyether polyols.

Examples of dibasic acids include carboxylic acids (for example, succinic acid, adipic acid, sebacic acid, dimer acid, maleic acid, phthalic acid, isophthalic acid, and terephthalic acid), and anhydrides of carboxylic acids.

Examples of cyclic ester compounds include ε-caprolactone, and β-methyl-δ-valerolactone.

Here, the non-radiation-curable polymer may be used in combination with polyols together with the various polyols. In particular, polyols may be used in combination with polyester polyols. That is, as the non-radiation-curable polymer, mixtures of polyester polyols and polyols are exemplified.

The content of polyols used in combination with the various polyols may be 30% by weight to 60% by weight (preferably, 35% by weight to 50% by weight), based on the total amount of the radiation-curable polymer. Particularly, when a mixture of polyester polyols and polyols is used, the weight ratio thereof (polyester polyol/polyol) may be 30/70 to 10/90 (preferably, 25/75 to 20/80).

Here, examples of polyols are the same as those of polyols exemplified in the description of polyether polyols.

Weight Average Molecular Weight of Non-Radiation-Curable Polymer

The weight average molecular weight of the non-radiation-curable polymer is preferably 200 to 1,000, and more preferably 250 to 850.

The weight average molecular weight of the non-radiation-curable polymer is a value measured by gel permeation chromatography (GPC) using polystyrene as a standard substance.

Content of Plasticizer

The content of the plasticizer is preferably 25% by weight to 60% by weight, more preferably 30% by weight to 55% by weight, and still more preferably 35% by weight to 50% by weight, based on the total amount of the support material.

The non-radiation-curable polymer may be used alone or in a combination of two or more.

Here, since the support material contains the plasticizer, the content of the radiation-curable compound is preferably 40% by weight to 75% by weight, and more preferably 50% by weight to 65% by weight, based on the total amount of the support material.

Particularly, even in the support material, similarly to the model material, preferably, the radiation-curable compound is used in combination with urethane (meth)acrylate and the above other radiation-curable compounds. In this case, the content of urethane (meth)acrylate is preferably 5% by weight to 45% by weight, and more preferably 10% by weight to 35% by weight, based on the total amount of the support material. Meanwhile, the content of the above other radiation-curable compounds is preferably 10% by weight to 70% by weight, and more preferably 20% by weight to 65% by weight, based on the total amount of the support material.

Three-Dimension Forming Composition Set

The three-dimension forming composition set according to the present exemplary embodiment includes a model material (three-dimension forming material) containing a radiation-curable compound; and a support material (three-dimension forming support material) containing a radiation-curable compound, a gas generating component, and a plasticizer.

Particularly, the support material, as described above, for example, may be a support material including a radiation-curable compound, a gas generating component containing water or containing water and a blocked isocyanate, and a plasticizer. Specific examples of the support material include: 1) a support material including a radiation-curable compound, a gas generating component containing water and a blocked isocyanate, and a plasticizer; and 2) a support material including a radiation-curable compound, a gas generating component containing water, a hydrophilic compound different from the radiation-curable compound, and a plasticizer. However, preferably, the support material 1) also include a hydrophilic compound, from the viewpoint of stably retaining water in the support material.

### EXAMPLES

Hereinafter, the present invention will be described in more detail based on the following Examples. However, the present invention is not limited thereto. Here, “part” means “part by weight” unless otherwise defined.

Model Material MA 1

Urethane acrylate oligomer: 14.6 parts by weight (“U-200PA”, manufactured by Shin-Nakamura Chemical Co., Ltd.)

Urethane acrylate oligomer: 15.2 parts by weight (“UA-4200”, manufactured by Shin-Nakamura Chemical Co., Ltd.)

Acrylate monomer: 30.1 parts by weight (“VEEA-AI”, manufactured by Nippon Shokubai Co., Ltd., 2-(2-vinyloxyethoxy)ethyl acrylate)

Acrylate monomer: 34.3 parts by weight (“IBXA”, manufactured by Osaka Organic Chemical Industry Co., Ltd., isobornyl acrylate)

Polymerization inhibitor: 0.5 parts by weight (MEHQ (hydroquinone monomethyl ether))

Polymerization initiator: 2.0 parts by weight (“LUCIRIN TPO”, manufactured by BASF Corporation, 2,4,6-trimethylbenzoyl-diphenyl-phosphine oxide)

Polymerization initiator: 2.0 parts by weight (“Irgacure 819”, manufactured by BASF Corporation, bis(2,4,6-trimethylbenzoyl)-phenyl phosphine oxide)

Polymerization initiator: 0.5 parts by weight (“Irgacure 379”, manufactured by BASF Corporation, 2-dimethylamino-2-(4-methylbenzyl)-1-(4-morpholin-4-yl-phenyl)-butan-1-one)

Sensitizer: 0.5 parts by weight (ITX (2-isopropylthioxanthone))

Cyan pigment: 0.1 parts by weight (“KY410-4B” manufactured by Taisei Kako Co., Ltd.)

Surfactant: 0.2 parts by weight (“TEGO Wet 270”, manufactured by Evonik Japan Inc., polyether modified siloxane copolymer)

The above components are mixed to prepare model material MA 1.

Support Material SA 1

Urethane acrylate oligomer: 13.0 parts by weight (“Alpha Resin UV-5000-I”, manufactured by Alpha-kaken Co., Ltd.)

Acrylate monomer: 16.3 parts by weight (“New Frontier PE-400”, manufactured by DKS Co., Ltd., polyethylene glycol 400 diacrylate)

Acrylate monomer: 18.5 parts by weight (“New Frontier ME-3”, manufactured by DKS Co., Ltd., methoxy triethylene glycol acrylate)

Polymerization inhibitor: 0.3 parts by weight (MEHQ (hydroquinone monomethyl ether))

Polymerization initiator: 2.0 parts by weight (“LUCIRIN TPO”, manufactured by BASF Corporation, 2,4,6-trimethylbenzoyl-diphenyl-phosphine oxide)

Polymerization initiator: 0.7 parts by weight (“Irgacure 379”, manufactured by BASF Corporation, 2-dimethylamino-2-(4-methylbenzyl)-1-(4-morpholin-4-yl-phenyl)-butan-1-one)

Sensitizer: 0.7 parts by weight (ITX (2-isopropylthioxanthone))

Hydrophilic compound (hydrophilic monomer): 6.5 parts by weight (DAAM (diacetone acrylamide))

Gas generating component (water): 6.5 parts by weight

Polyether polyol: 35.0 parts by weight (“Adeka polyether P-400”, manufactured by ADEKA Corporation)

Surfactant: 0.7 parts by weight (“TEGO Wet 270”, manufactured by Evonik Japan Inc., polyether modified siloxane copolymer)

The above components are mixed to prepare support material SA 1.

Support Material SA 2

Urethane acrylate oligomer: 11.7 parts by weight (“Alpha Resin UV-5000-I”, manufactured by Alpha-kaken Co., Ltd.)

Acrylate monomer: 13.7 parts by weight (“New Frontier PE-400”, manufactured by DKS Co., Ltd., polyethylene glycol 400 diacrylate)

Acrylate monomer: 15.9 parts by weight (“New Frontier ME-3”, manufactured by DKS Co., Ltd., methoxy triethylene glycol acrylate)

Polymerization inhibitor: 0.3 parts by weight (MEHQ (hydroquinone monomethyl ether))

Polymerization initiator: 2.0 parts by weight (“LUCIRIN TPO”, manufactured by BASF Corporation, 2,4,6-trimethylbenzoyl-diphenyl-phosphine oxide)

Polymerization initiator: 0.7 parts by weight (“Irgacure 379”, manufactured by BASF Corporation, 2-dimethylamino-2-(4-methylbenzyl)-1-(4-morpholin-4-yl-phenyl)-butan-1-one)

Sensitizer: 0.7 parts by weight (ITX (2-isopropylthioxanthone))

Hydrophilic compound (hydrophilic monomer): 6.5 parts by weight (DAAM (diacetone acrylamide))

Gas generating component (water): 6.5 parts by weight

Gas generating component: 6.5 parts by weight (blocked isocyanate compound “Karenz MOI-BM”, manufactured by SHOWA DNKO K.K, methacrylic acid 2-(0-[1′-methylpropylidene amino] carboxy amino) ethyl)

Polyether polyol: 35.0 parts by weight (“Adeka polyether P-400”, manufactured by ADEKA Corporation)

Surfactant: 0.7 parts by weight (“TEGO Wet 270”, manufactured by Evonik Japan Inc., polyether modified siloxane copolymer)

The above components are mixed to prepare support material SA 2.

### Example 1

A plate-shaped structure having a thickness of 100 is formed on a glass substrate using model material MA1. Two sheets of the plate-shaped member are attached such that the plate-shaped structures face each other, a gap is formed using a Teflon (registered trademark) sheet having a thickness of 25 μm as spacer, and support material SA1 is injected through the gap using a capillary phenomenon and cured, so as to form a plate-shaped support portion having a thickness of 25 μm and made of a cured product of the support material SA1. The resulting laminate, which is composed of the glass substrates between which the plate-shaped structures and the plate-shaped support portion are laminated, is put into a furnace preheated to 110° C., and is kept for 5 minutes to 10 minutes, so as to generate water vapor in the support portion. Thereafter, the glass substrate is taken out from the furnace and cooled to room temperature. Then, the two glass substrates are removed by stripping these glass substrates with bare hands. In this case, comparing the forces applied when the two glass substrates are removed by stripping these glass substrates with bare hands before and after putting the glass substrate into the furnace, the two glass substrates are not drawn and stripped before the glass substrates are put into the furnace, but are simply stripped after the glass substrates are put into the furnace. Further, it is difficult to pulverize the support portion.

Another test is carried out in the same manner above, except that support material SA2 is used. In this case, the same results are obtained in that water vapor and carbon dioxide are generated in the support portion.

### Example 2

A plate-shaped structure having a thickness of 100 μm is formed on a glass substrate using model material MA1. Two sheets of the plate-shaped member are attached such that the plate-shaped structures face each other, a gap is formed using a Teflon (registered trademark) sheet having a thickness of 25 μm as spacer, and a plate-shaped support portion having a thickness of 25 μm and made of a cured product of the support material SA1 is formed. The resulting laminate, which is composed of the glass substrates between which the plate-shaped structures and the plate-shaped support portion are laminated, is put into a microwave oven. The support portion is irradiated with microwaves under the conditions of a frequency of 2.45 MHz, a power of 500 W, and an irradiation time of 2 minutes, so as to generate water vapor in the support portion. Thereafter, the glass substrate is taken out from the microwave oven and cooled to room temperature. Then, the two glass substrates are removed by stripping these glass substrates with bare hands. In this case, comparing the forces applied when the two glass substrates are removed by stripping these glass substrates with bare hands before and after putting the glass substrate into the microwave oven, the two glass substrates are not drawn and stripped before the glass substrates are put into the microwave oven, but are simply stripped after the glass substrates are put into the microwave oven. Further, it is difficult to pulverize the support portion.

Another test is carried out in the same manner above, except that support material SA2 is used. In this case, the same results are obtained in that water vapor and carbon dioxide are generated in the support portion.

From the above results of these examples, it is found that the strippability of the support portion is improved when preparing the three-dimensional structure. Further, it is found that the removal of the support portion is realized in a short period of time. Furthermore, it is found that the excessive pulverization of the support portion is prevented.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method of preparing a three-dimensional structure, comprising:
forming a structure made of a cured product of a three-dimension forming material;
forming a support portion which supports at least apart of the structure and includes a gas generating component at least at a site which contacts with the structure;
generating a gas in the support portion, the gas being derived from the gas generating component; and
removing the support portion from the structure.

2. The method of preparing a three-dimensional structure according to claim 1, wherein the gas derived from the gas generating component is generated in the support portion by heating or microwave irradiation.

3. The method of preparing a three-dimensional structure according to claim 1, wherein the gas derived from the gas generating component is at least one of water vapor and carbon dioxide.

4. The method of preparing a three-dimensional structure according to claim 1, wherein the support portion includes a first support portion which contains the gas generating component and contacts with the structure to support the structure, and a second support portion which supports the structure through the first support portion.

5. The method of preparing a three-dimensional structure according to claim 4, wherein the support portion further includes a third support portion which includes the gas generating component and divides the second support portion into a plurality of sections.

6. The method of preparing a three-dimensional structure according to claim 4, wherein the second support portion has a plurality of protrusions projecting toward the first support portion.

7. The method of preparing a three-dimensional structure according to claim 1, wherein at least the site, which contacts with the structure, of the support portion is formed by a three-dimension forming support material containing water or containing water and a blocked isocyanate compound as the gas generating component.

8. The method of preparing a three-dimensional structure according to claim 7, wherein the content of each of the water and the blocked isocyanate compound is 5% by weight to 20% by weight with respect to a total amount of the three-dimension forming support material.

9. A three-dimension forming support material, comprising:
a radiation-curable compound;
a gas generating component containing water and a blocked isocyanate compound; and
a plasticizer.

10. A three-dimension forming support material, comprising:
a radiation-curable compound;
a gas generating component containing water;
a hydrophilic compound which is different from the radiation-curable compound; and
a plasticizer.
